(19) United States
(12) Patent Application Publication
(10) Pub. No.: US 2026/0340028 A1
(43) Pub. Date: Oct. 29, 2026

(54) ARTIFICIAL INTELLIGENCE ENABLED MULTI-SENSOR SYSTEM FOR ENHANCING PERSONNEL-DRIVEN SECURITY ACTIVITIES

(71) Applicant: CONSTELLIS, LLC, Herndon, VA (US)

(72) Inventors: Terrence Michael RYAN, Alexandria, VA (US); Donald Roger SEMON, Falls Church, VA (US); Srinivas Y. REDDY, McLean, VA (US); Amarendranath VADLAMUDI, Rockville, MD (US); Edwin Raymond STOLL, Canton, OH (US)

(21) Appl. No.: 19/199,128

(22) Filed: May 5, 2025

Related U.S. Application Data
(60) Provisional application No. 63/642,812, filed on May 5, 2024.

(51) Int. Cl. G06F 16/54; G06F 16/532; G06F 16/55; G06V 20/52

(52) U.S. Cl. CPC G06F 16/54; G06F 16/532; G06F 16/55; G06V 20/52

(57) ABSTRACT

A multi-modal sensor system includes a plurality of sensors and one or more processors. The one more processors ingest image data collected by the plurality of sensors. Then the one or more processors group the image data into batches. After the image data is batched, the one or more processors generate visual narratives for each of the batches by prompting a first generative artificial intelligence (AI) model. Then the visual narratives are input into a second generative AI model to detect anomalies.

### CROSS-REFERENCE TO RELATED APPLICATIONS

The present application claims benefit to U.S. Provisional Application No. 63/642,812 filed on May 5, 2024 and entitled “An Improved AI-Enabled Multi-Sensor System for Enhancing Personnel-Driven Security Activities,” which is herein incorporated by reference in its entirety.

### BACKGROUND

Sensor systems play a crucial role in modern security systems. For example, sensor systems may trigger alarms or initiate other security measures based on detected changes within an environment. However, despite their benefits, sensor systems may struggle to accurately process multi-modal data or detect security events in real time.

### BRIEF DESCRIPTION OF THE DRAWINGS/FIGURES

The accompanying drawings are incorporated herein and form a part of the specification.

FIGS. 1A and 1B show an example multi-sensor system, according to some aspects.

FIG. 2 shows an example process for detecting and reacting to security events, according to some aspects.

FIG. 3 shows an example process for implementing conflict management between conflicting actions in a multi-modal sensor system, according to some aspects

FIG. 4 shows an example process for ingesting and analyzing sensor data in real time using artificial intelligence models, according to some aspects.

FIG. 5 shows an example computer system, according to some aspects.

In the drawings, like reference numbers generally indicate identical or similar elements. Additionally, generally, the left-most digit(s) of a reference number identifies the drawing in which the reference number first appears.

### DETAILED DESCRIPTION OF THE INVENTION

Provided herein are system, apparatus, device, method, and/or computer program product aspects, and/or combinations and sub-combinations thereof for facilitating seamless, real-time integration of sensors, efficient sensor orchestration, and/or enhanced security. As described herein, real-time refers to the ability of a system or process to respond to input and complete its designated task with no noticeable delay between the input and its effect or consequence (e.g., within milliseconds).

In some aspects, a multi-modal sensor system includes a plurality of sensors coupled to one or more processors. The one or more processors may implement a microservices architecture, which comprises a plurality of independent services configured to ingest and analyze data collected by the sensors. Data integration and analysis services within the multi-modal sensor system may be configured to ingest and analyze the data in real-time, or near real-time. In one example, a data integration service may pre-process the data. Then, a data processing service may batch the pre-processed data and send it to one or more processors (e.g., graphical processing units) that leverage a first generative artificial intelligence model to create a visual narrative (e.g., text summary) of the data. The one or more processors may then leverage a second generative AI model to identify anomalies within the visual narrative.

In some aspects, the data integration and analysis services within the multi-modal sensor system may submit events (e.g., detected anomalies, etc.) to an event broker. Other services in the multi-modal sensor system may subscribe to the events via the event broker. In some aspects, an event may trigger a reactor service (e.g., rule engine) to initiate a command sequence that controls actions of one or more of the sensors. For example if an acoustic sensor detects a potential intruder (e.g., breaking glass or gun shots), the reactor may instruct nearby optical sensors to pivot towards the source of the sound and begin recording. The reactor may determine the set of commands based on a set of predefined playbooks, and/or by leveraging an artificial intelligence (AI) model. The multi-modal sensor system may also implement rule-based queuing strategies to prioritize conflicting commands.

In some aspects, the multi-modal sensor system streams collected data, analysis events, and the like to a user. For example, the multi-modal sensor system may stream video and/or fused datasets to a client device in real time or near real time. The multi-modal sensor system may also leverage a notification service to stream detected events to the user.

The aspects described herein provide direct technological improvements over traditional sensor systems by effectively processing (e.g., more accurate and computationally efficient processing) diverse sensor inputs. Traditional sensor systems may struggle to manage diverse inputs from various sensor types, each with unique data formats and/or frequencies. Aspects described herein solve these technological challenges through the use of robust preprocessing pipelines that synchronize and standardize this data for AI processing.

The aspects described herein also provide direct technological improvements over traditional sensor systems by enabling the processing of data in real time or near real time. Traditional sensor system are often unable to process information in real time, particularly with strict latency demands. The aspects described herein may reduce latency through techniques including, but not limited to, model pruning, batch processing, prompt engineering, and/or edge computing.

The aspects described herein may also improve the functioning of a computer system. For example, the batch processing strategies disclosed herein may optimize memory usage within one or more processors. Furthermore, effective prompt engineering and design of artificial intelligence models may improve efficiency of data processing. This saves the computational time and resources that would have otherwise been expended to analyze sensor data. These technical advantages may be appreciated, for example, in resource-constrained environments that must analyze multi-modal data with low latency. The overall computational efficiency of these systems may be improved as a result and the conserved resources may be reallocated for other tasks. Additionally, aspects described herein utilize improved prompt engineering that translates to fewer computational errors and higher performance accuracy.

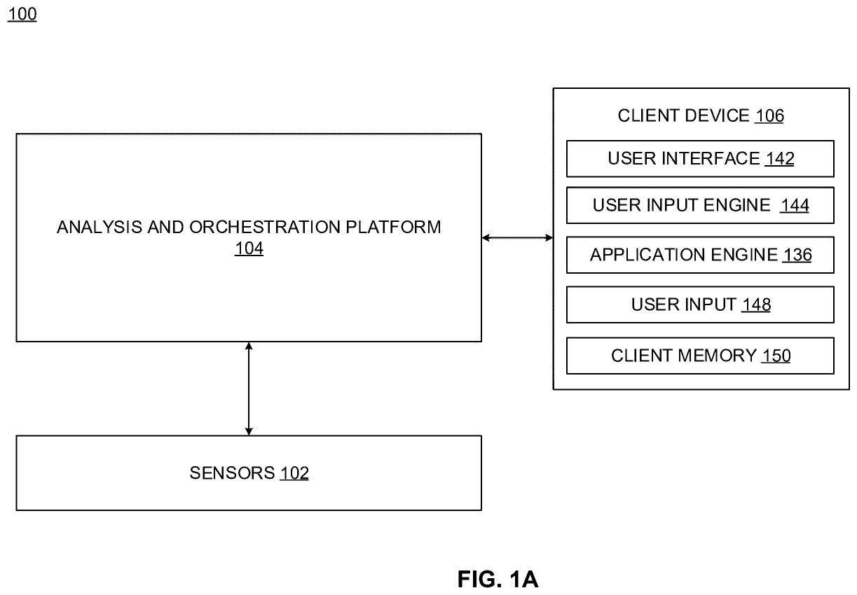

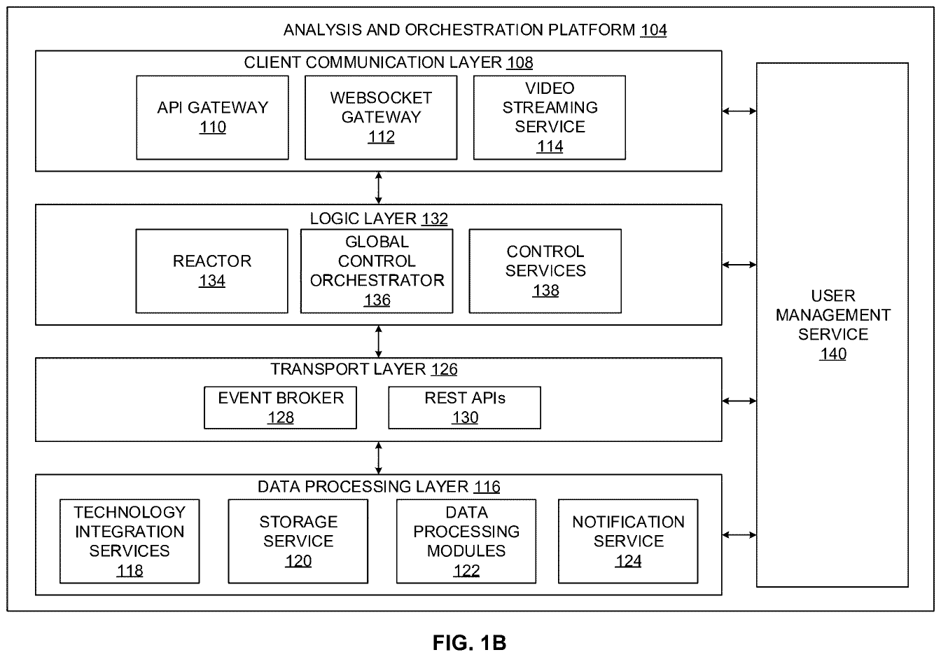

Various aspects of this disclosure may be implemented using and/or may be a part of the example multi-modal sensor system shown in FIGS. 1A and 1B. It is noted, however, that these environments are provided solely for illustrative purposes, and are not limiting. Aspects of this disclosure may be implemented using and/or may be part of environments different from and/or in addition to the multi-modal sensors system as will be appreciated by persons skilled in the relevant art(s) based on the teachings contained herein.

An example of the multi-modal sensor system shall now be described.

FIGS. 1A and 1B show an example block diagrams of a multi-modal sensor system 100, according to some aspects. Operations described may be implemented by processing logic that may comprise hardware (e.g. circuitry, dedicated logic, programmable logic, microcode, etc.), software (e.g. instructions executing on a processing device), or a combination thereof. It is to be appreciated that not all operations may be needed to perform the disclosure provided herein. Further, some of the operations may be performed simultaneously, or in a different order than described for FIGS. 1A and 1B, as will be understood by a person of ordinary skill in the art.

Example multi-modal sensor system 100 may include sensors 102, an analysis and orchestration platform 104, and a client device 106. In some aspects, sensors 102, analysis and orchestration platform 104, and client device 106 may be communicatively coupled with each other via one or more networks, such as one or more wired or wireless local area networks (“LANs,” including Wi-Fi, mesh networks, Bluetooth, near-field communication, etc.) or wide area networks (“WANs”, including the Internet).

Sensors 102 may include any combination of visible sensors (e.g., cameras), depth sensors, radar sensors, LiDAR sensors, infrared sensors, acoustic sensors, seismic sensors, and the like. Sensors 102 may be connected to actuators and/or robotic systems (e.g., unmanned aerial system, robotic dog, etc.) that control movements of sensors 102. In some aspects, sensors 102 are deployed to perform monitoring and surveillance tasks for businesses, critical infrastructure, government facilities, etc. For example sensors 102 may collect data related to changes in an environment that is used to trigger alerts or send notifications to security personnel. Data collected by sensors 102 may be ingested and analyzed by analysis and orchestration platform 104. Additionally or alternatively, sensors 102 may include local data processing capabilities that allow data to be preprocessed and/or analyzed directly by the sensors. For example, an acoustic sensor may be configured to detect abnormal sounds.

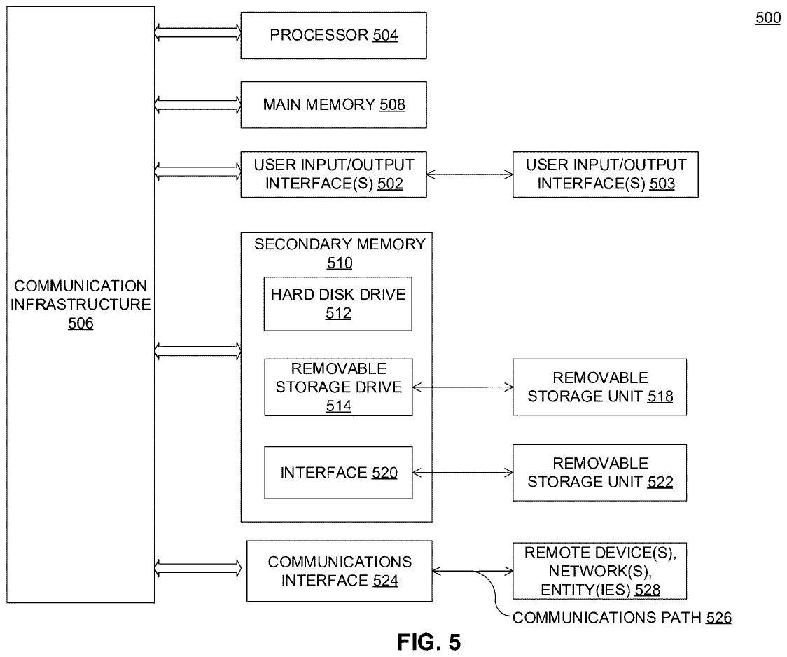

Analysis and orchestration platform 104 may be configured to ingest and analyze data from the plurality of sensors 102. Additionally, analysis and orchestration platform 104 may be configured to orchestrate control of the plurality of sensors 102 to meet security objectives. Security objectives may include monitoring an area, detecting anomalies and threats, and responding to the anomalies and threats in real time or near real time. Analysis and orchestration platform 104 may be implemented in one or more computer systems, such as computer system 500 in FIG. 5. The one or more computing systems may include edge computing nodes.

In some aspects, analysis and orchestration platform 104 implements a microservices architecture, in which an application is structured as a collection of small, independently deployable micro services that communicate with each other using lightweight protocols (e.g., APIs). Each micro service may include its own codebase, database, and deployment process, allowing for independent scaling, updating, and testing. In some aspects, each individual micro service may be containerized. The micro services may be managed and deployed via an orchestration platform, such as Kubernetes.

Examples of micro services within analysis and orchestration platform 104 may now be described.

In some aspects, analysis and orchestration platform 104 may include a client communication layer 108. Client communication layer 108 may include micro services that provide capabilities for transmitting data to/from one or more client devices 106. Client communication layer 108 may include an API gateway 110, a WebSocket gateway 112, and a video streaming service 114.

API gateway 110 may provide authentication, data aggregation, and routing capabilities between a client device (e.g., client device 106) and other micro services within analysis and orchestration platform 104. For example, API gateway 110 may act as an external entry point for client requests, which, upon receipt, are forwarded to an appropriate micro service. In another example, API gateway 110 may interface with user management service 140 for token validation. Then, API gateway 110 may enforce authentication for other micro services within analysis and orchestration platform 104. Furthermore, API gateway 110 may integrate with an API management layer (e.g., Kong, NGINX, or Envoy) to implement advanced features. API gateway 110 may communicate with other micro services via a REST APIs 130 and/or by publishing notifications to event broker 128. When needed, API gateway 110 may aggregate responses from other micro services.

In some aspects, WebSocket gateway 112 provides bi-directional, real-time communication between analysis and orchestration platform 104 and one or more client devices 106. WebSocket gateway 112 may handle high-bandwidth or specialized streaming protocols, such as LiDAR object updates and notifications. In some aspects, WebSocket gateway 112 may offload real-time streaming from API gateway 110, thus preventing server overload (e.g., more requests than a server can handle with its current resources) due to persistent connections. WebSocket gateway 112 may subscribe to event topics published by event broker 128 and push messages related to the event topics to connected client devices 106. In some aspects, WebSocket gateway 112 works with user management service 140 to validate a client device 106 before allowing access to event topics. WebSocket gateway 112 may form connections with multiple clients through a websocket handshake (HTTP upgrade) and remain open for event streaming. In some aspects, WebSocket gateway 112 may implement advanced features like message buffering, topic-based subscriptions, or presence (e.g., display online users).

In some aspects, video streaming service 114 provides streaming for high-bandwidth video. Video streaming service 114 may convert or relay video feeds captures by sensors 102 into a format consumable by a browser (e.g., WebRTC, HLS, DASH, etc.). Video streaming service 114 may manage multiple video feeds and may replicate the video streams or offload the video streams to a content delivery network (CDN). In some aspects, video streaming service 114 integrates with a camera service for controlling pan-tilt-zoom of a camera or starting and stopping streams. Video streaming service 114 may also integrate with user management service 140 or API gateway 110 to manage user access control. In some aspects, video streaming service 114 may leverage REST APIs 130 to create a video streaming sessions. Video streaming service 114 may stream video data flows over specialized protocols, such as WebRTC, HLS, and the like.

Analysis and orchestration platform 104 may further include a data processing layer 116. Data processing layer 116 may include data integration services 118, storage service 120, data processing modules 122, and notification service 124.

In some aspects, data integration services 118 may interface directly with external devices and sensors (e.g., cameras, LiDAR sensors, MCQ sensors, drones, robotic dogs, etc.). Data integration services 118 may include a separate integration service for each type of sensor. In some aspects, data integration services 118 preprocess and standardize raw data before it is sent to other micro services within analysis and orchestration platform 104. For example, data integration services 118 may preprocess, format and publish sensor telemetry and events (such as object detections or status updates) to event broker 128. In some aspects, data integration services 118 may be directly queried to determine a status or collect data from one of sensors 102. In some aspects, data integration services 118 may initiate direct commands, such as commands for drone or robot control. Additionally, data integration services 118 may integrate with global control orchestrator 136 to manage overrides or conflict resolution. For example, if one of data integration services 118 receives conflicting commands form reactor 134 and a user of client device 106, the data integration service may prompt the global control orchestrator to prioritize and queue the conflicting commands.

In some aspects, storage service 120 may act as a central repository for system configuration, event logs, historical sensor data, and metadata. In some aspects, storage service 120 is scalable for large volumes of sensor data when archiving full logs or video metadata. Storage service 120 may also store rules, policies, environmental configuration data, user profiles, hashed passwords, prompts, prompt templates, etc. In some aspects, storage service 120 handles direct create, read, update, and delete (CRUD) operations via REST APIs 130. Storage service 120 may also publish events to event broker 128 to notify other services of change events.

In some aspects, data processing modules 122 may analyze data collected from sensors 102. Data processing modules 122 may subscribe to events via event broker 128. After receiving data from the sensor, the data processing modules 122 may analyze the data to create summaries, generate predictions, fuse datasets, perform object tracking, etc. Data processing modules 122 may communicate their results to other micro services within analysis and orchestration platform 104 by publishing events to event broker 128 or by sending data directly to other micro services via REST APIs 130.

In some aspects, data processing modules 122 may include a visual summarization service. The visual summarization service may leverage a first large language model (LLM) to create text summaries of images captured by each visual sensor within sensors 102. The visual summarization service may then leverage a second large language model to enrich the text summaries for each visual sensor with additional context and/or to detect anomalies in the text summaries. The visual summarization service may maintain short-term event histories (e.g., 5-15 minute windows) for each sensor, which may be used to generate a combined summary that includes text data from all visual sensors.

In some aspects, data processing modules 122 may include one or more data fusion models. Data fusion models may, for example, combine information from multiple sensors to create a more comprehensive and accurate understanding of an environment. In some aspects data fusion models may combine different types of data (e.g., visual and audio data, visual and LiDAR data, etc.). Data fusion models may leverage several techniques, such as Kalman filters, Bayesian inference, Gaussian processes, convolutional neural networks, etc.

In some aspects, data processing modules 122 may include anomaly detection models. Anomaly detection is the process of identifying rare events, items, or observations that may differ significantly from standard behaviors or patterns. The anomaly events may be considered as unusual patterns in sensor data, including potential threats in the field. Anomaly detection models may first model the representation of normal behaviors, and then exploit this knowledge to identify anomalies. In some aspects, the anomaly models may use machine learning and/or deep learning techniques including but not limited to Autoencoders, Convolutional Neural Networks (CNNs), and Simple Recurrent Units (SRUs) to identify unusual activities or behaviors in image data, video data, and/or fused data (e.g., fused optical, seismo-acoustic and/or other physical data). Anomaly detection models may process and analyze extensive video feeds in real-time.

In some aspects, data processing modules 122 may include predictive analytics models. Predictive analytics models may use historical data and statistical techniques to forecast future outcomes. This may allow operators to anticipate and mitigate security threats before they occur. In some aspects, predictive analytics models may leverage data mining, machine learning and statistical models to identify patterns and trends that may be extrapolated to make predictions.

In some aspects, notification service 124 may provide a unified real-time or near real time mechanism to inform users of critical events, status updates and/or alerts. For example, notification service 124 may subscribe to, filter, and/or enrich multiple event topics (e.g., from different sensors). Notification service 124 may then consolidate the system events and into a single event feed, which may be sent to a user (e.g., via user interface 142 of client device 106). A user may be able to subscribe to relevant events only. In some aspects, the event feed is sent to the client via WebSocket gateway 112. Notification service 124 may rely on event broker 128 to receive events from multiple sources. In some aspects, notification service 123 logs consolidated event logs in storage service 120.

In some aspects, analysis and orchestration platform 104 may further include a transport layer 126. Transport layer 126 may include services for communicating data within analysis and orchestration platform 104. For example, transport layer 126 may include an event broker 128 and RESTful web application programming interfaces (REST APIs) 130.

Event broker 128 may provide asynchronous communication and event-driven architecture. For example, event broker 128 may ingest, store, and process real-time data received from micro services within analysis and orchestration platform 104. Event broker 128 may publish received data as events. Other micro services (e.g., reactor 134, storage service 120) within analysis and orchestration platform 104 may subscribe to the events.

Event broker may leverage existing software, such as olace PubSub+, Microsoft Azure Event Grid, IBM MQ, Confluent Cloud, TIBCO Messaging, RabbitMQ, and Apache Kafka.

REST APIs 130 provide synchronous communication between services within analysis and orchestration platform 104. REST APIs 130 may exchange data between micro services using the HTTP protocol. For example, a first micro service may sends a request to a second micro service, specifying the desired resource and the action to be performed (like retrieving, creating, updating, or deleting data), and the second micro service responds with the requested data or a confirmation of the action taken.

In some aspects, analysis and orchestration platform 104 may further include a logic layer 132. Logic layer 132 may determine actions based on detected events. The logic layer may include a reactor 134, a global control orchestrator 136, and control services 138.

In some aspects, reactor 134 acts as an event-driven rule engine within analysis and orchestration platform 104. Reactor 134 may subscribe to event topics via event broker 128. Upon receiving an event, reactor 134 may check user defined automation rules, policies, and thresholds stored in storage service 120. If an event or other condition matches a predefined criteria, reactor 134 may initiate a set of commands. In some aspects the set of commands is outlined in one or more playbooks. For example if an acoustic sensor detects a potential intruder (e.g., breaking glass or gun shots), a playbook may trigger nearby optical sensors to pivot towards the source of the sound and begin recording. Similarly, an intrusion detection playbook may be triggered by motion sensors detecting movement in a restricted area during off-hours. Actions of this playbook might include but are not limited to turning on lights, activating sensors to track movement, sending an alert to a security dashboard, and notifying local security personnel. Additionally or alternatively, reactor 134 may leverage artificial intelligence models to determine subsequent actions when an event or condition matches a predefined criteria. If multiple actions overlap with each other, reactor 134 may coordinate with global control orchestrator 136 for final conflict resolution.

Reactor 134 may communicate actions (e.g., commands) to sensors 102 and/or control services 138 directly via REST APIs 130 or by publishing commands to event broker 128. In some aspects, reactor 134 handles complex workflows, such as active tracking and/or multi-device coordination, by linking logic blocks together.

In some aspects, global control orchestrator 136 may resolve conflicts and manage transitions between user-driven and automated control across all integrated devices (e.g., sensors). For example, if both an operator and an active tracking AI module attempt to control a sensor simultaneously, reactor 134 may defer final arbitration to global control orchestrator 136. In some aspects, global control orchestrator 136 may prioritize commands based on predefined rules and the criticality of events. For example, global control orchestrator may prioritize user commands over automated commands initiated by reactor 134. In some aspects, global control orchestrator 136 may implement advanced logic for multi-device orchestration (e.g., when more than one camera or drone is interacting with the same target). Global control orchestrator 136 may communicate actions (e.g., commands) to sensors 102 and/or control services 138 directly via REST APIs 130 or by publishing commands to event broker 128.

In some aspects, control services 138 provide control for sensors and robotic elements during active control. Analysis and orchestration platform 104 may include a separate control service for each type of sensor and/or device in multi-sensor system 100. In one non-limiting example, control services 138 may include a camera service. The camera service may provide a singular command and control interface for managing a plurality of cameras. This prevents conflicts by centralizing all camera commands. The camera service may expose REST endpoints for simple commands, such as pan, tilt, and zoom and implement local arbitration logic (e.g., using asynchronous tasks or threads) for advanced operations, like active tracking. The camera service may also interface with video streaming service 114 to coordinate stream URLs or real-time streaming protocol (RTSP) endpoints.

In some aspects, control services may receive direct commands from reactor 134 and global control orchestrator 136 via REST APIs 130 and/or from a user via API gateway 110. Additionally or alternatively, control services 138 may receive commands by subscribing to event topics via event broker 128 (e.g., to receive high-priority automation or override signals). In some aspects, control services 138 may log events related to a sensor and send to storage service 120 and/or event broker 128 for auditing.

In some aspects, analysis and orchestration platform 104 may also include a user management service 140. User management service 140 may handle authentication, authorization and user profile management for clients accessing analysis and orchestration platform 104. For example, user management service 140 may manage logins, issue tokens (JWT/OAuth), and/or implement role based access control. User management service 140 may fetch user profiles, hashed passwords, etc. from storage service 120. In some aspects, user management service 140 handles token validation/refresh logic that is recognized by other services within analysis and orchestration platform 104. To communicate with other services, user management service 140 may leverage REST APIs 130 and/or may publish user activity events to event broker 128 for system wide auditing.

Client device 106 may be one or more of a desktop computer, a laptop computer, a tablet, a mobile phone, other handheld devices, a smart appliance such as a smart television, and/or a wearable apparatus of the user that includes a computing device (e.g. a smartwatch, smart glasses, or a virtual or augmented reality computing device). Additional and/or alternative client devices may be contemplated. Client device 106 may include a corresponding user interface 142, user input engine 144, application engine 146, user input 148, and client memory 150.

User interface 142 may be configured to render content including unimodal responses, multimodal responses, or other content for audible or visual presentation to a user of client device 106 using one or more user interface output devices. For example, client device 106 may include a display or projector that enables content to be provided for visual presentation to a user via client device 106. Alternatively or additionally, client device 106 may include one or more speakers that enable content to be provided for audible presentation to a user via client device 106. In some aspects, user interface 142 provides user interaction and visualization of real-time data and system status. For example, user interface may display a common operating picture (COP) for live geospatial visualization.

Application engine 146 may execute one or more software applications on client device 106. In some aspects, application engine 146 may submit instructions to analysis and orchestration platform 104. Application engine 146 may also receive data, such as video streams, notifications, text summaries, etc., from analysis and orchestration platform 104, which may be rendered onto user interface 142 (e.g., audibly and/or visually). Application engine 146 may execute one or more software applications that are separate from an operating system of the client device 106 or may alternatively be implemented directly by the operating system of client device 106. For example, the application engine 146 may execute one or more software applications via a web browser or assistant.

User input 148 may represent an input provided by a user of client device 106 and may be detected via user input engine 144. For example, user input 148 may include instructions for controlling a sensor or device. In some aspects, user input 148 may be a typed query that is typed via a physical or virtual keyboard, a suggested query that is selected via a touch screen or a mouse of client device 106, a spoken voice query that is detected via a microphone of client device 106 (or directed to an voice assistant running at client device 106), or an image or video query that is based on vision data captured by a vision component of client device 106.

Client memory 150 may include a data store containing data about a user of client device 106 or about client device 106 itself. In some aspects, client memory 150 may store one or more instructions (e.g. user input 148) submitted by a user of client device 106. Client memory 150 may also store user interaction data about current or recent interactions between a user or multiple users and client device 106. In some aspects, client memory 150 may also store location data about current or recent locations of client device 106 or a geographical region associated with a user of client device 106. Client memory 150 may also store user attribute data, user preference data, a user profile, or various configurations relating to client device 106 or a user of client device 106. In some aspects, the data stored in client memory 150 may be communicated partially or entirely to analysis and orchestration platform 104.

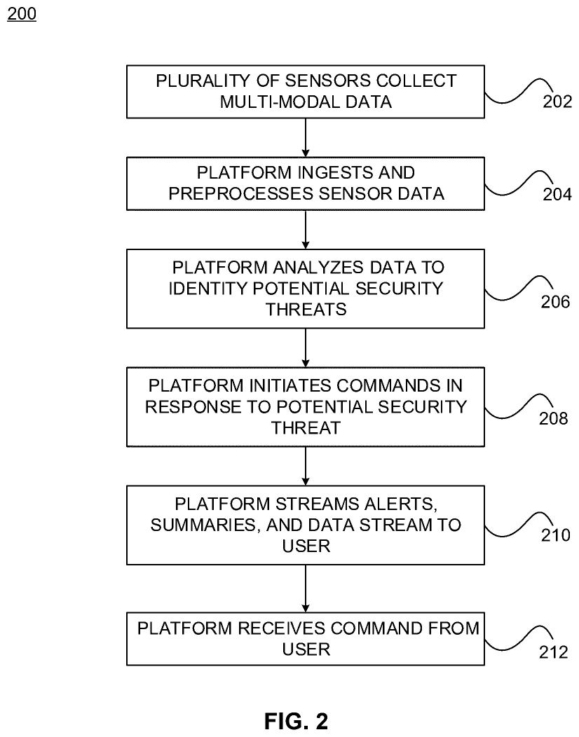

FIG. 2 shows a flowchart of an example process 200, according to some aspects. Process 200 may describe a method for detecting and reacting to security events. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 2, as will be understood by a person of ordinary skill in the art. Process 200 shall be described with reference to FIG. 1. However, process 200 is not limited to those example aspects.

At 202, a plurality of sensors (e.g., plurality of sensors 102) may collect data. The plurality of sensors may include cameras, LiDAR sensors, etc. Data may be collected continuously, at predefined intervals, or when a sensor is triggered (e.g., a motion sensor).

At 204, analysis and orchestration platform 104 may ingest the data collected by sensors 102. In some aspects, analysis and orchestration platform 104 may leverage technology integration services 118 to ingest and preprocess the data. For example, technology integration services 118 may collect, synchronize, time stamp, normalize, and/or format the data. The data is then published as events (e.g., sensor events) to event broker 128. In some aspects, analysis and orchestration platform 104 may implement an intelligent pre-fetching algorithm for proactively retrieving image fragments ahead of scheduled inference cycles. The pre-fetching mechanism can anticipate data needs based on recent sensor activity, historical data rates, and/or sensor-specific triggers, allowing the analysis and orchestration platform to maintain low-latency processing, even under varying network conditions.

At 206, analysis and orchestration platform 104 may analyze the sensor data. For example, analysis and orchestration platform 104 may leverage one or more of data processing modules 122 to process the data. Data processing modules 122 may subscribe to sensor events via event broker 128. After receiving sensor data from the event broker, the data processing modules may process the data to identify patterns or events that require attention (e.g., suspicious objects, sounds, activity, etc.). For example, one of the data processing modules may leverage generative artificial intelligence to generate situational narratives from images data. Another of the data processing modules may fuse data streams together (e.g., visual and acoustic data, visual and LiDAR data, etc.). Yet another of the data processing modules may perform predictive analytics on the incoming sensor data. After completing their respective analyses, the data processing modules may publish their results as analysis events to event broker 128. The analysis events may indicate potential security threats.

At 208, analysis and orchestration platform 104 may initiate automated or user commands in response to a potential security threat. In some aspects, reactor 134 within analysis and orchestration platform 104 may execute one or more control sequences. For example, reactor 134 may subscribe to sensor and analysis events via event broker 128. The reactor 134 may be triggered by sensor events that match predefined criteria. Then, reactor 134 may determine an action for one or more of sensors 102 based on user-defined automation rules, policies, and thresholds stored within storage service 120. After determining an action, the reactor may publish a command to event broker 128 or send a REST API call directly to one of control services 138 (e.g., a camera service) to initiate the action. For complex scenarios, such as multi-device coordination, the reactor may publish and/or send multiple commands. For example, reactor 314 may send a first command to a camera service to track a target and a second command to a drone integration service to deploy and investigate suspicious activity within an area.

In some aspects, reactor 134 initiates commands based on one or more playbooks (e.g., set of automation rules for responding to a situation). The playbooks may define conditions using a combination of Boolean logic, comparative statements, and event-type identifiers. These conditions can be established upfront during the playbook creation phase and refined dynamically based on ongoing learning from system interactions and false positives or negatives. Also, the playbooks may define examples of actions including but not limited to sending notifications, activating or deactivating hardware (e.g., lights or locks), and logging events for further analysis. These actions can follow a predefined sequence or be dynamically constructed based on the scenario's complexity and the real-time data from various sensors.

In some aspects, reactor 134 may leverage an artificial intelligence model to evaluate a “best fit playbook” based on the received events. For example, reactor 134 may prompt a generative AI model (e.g., large language model) to evaluate which playbook to leverage passed on severity of an event, sensor confidence, cross-sensor correlation, user defined parameters, and the like.

In an alternative aspect, reactor 134 may leverage a deterministic rule engine to choose a playbook. For example, if a data processing module detects a person loitering near a fence, the deterministic rule engine may perform the following logic: “IF loitering AND time >10 PM, trigger playbook 5.”

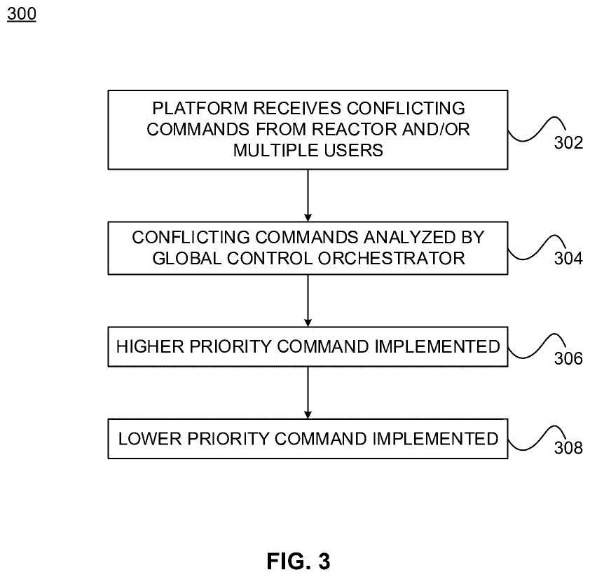

In addition to automatic commands implemented by reactor 134, analysis and orchestration platform 104 may receive commands from a user of client device 106. For example, user may submit a command via user interface 142. If the user command and an automated command initiated by reactor 134 conflict, analysis and orchestration platform 104 may leverage global control orchestrator 136 to resolve the conflict. More information on conflict resolutions processes are given below in reference to FIG. 3.

While reactor 134 determines and initiates actions for sensors 102, the analysis and orchestration platform 104 may simultaneously stream sensor data to a user (e.g., a user of client device 106).

For example, at 210, analysis and orchestration platform 104 may send alerts, summaries, data streams, and the like to one or more users of one or more client devices 106. Analysis and orchestration platform 104 may leverage API gateway 110, WebSocket gateway 112, and/or video streaming services to send data to the one or more client devices.

At 212, analysis and orchestration platform 104 may receive a command from a user in response to the alerts, summaries, and/or data streams sent at 210. Analysis and orchestration platform 104 may receive the command via API gateway 110. After a user command is received, process 200 may return to 208.

In some aspects, process 200 may be repeated continuously.

Examples of specific methods for detecting and reacting to security events have been described herein. However, these examples are not meant to be limiting nor meant to represent an exhaustive list of possible implementations. The scope of the technology disclosed herein is not limited to only these examples, and other implementations are contemplated as appreciated by one skilled in the art.

FIG. 3 shows an example process 300, according to some aspects. Process 300 may describe conflict management between conflicting commands within an analysis and orchestration platform. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 3, as will be understood by a person of ordinary skill in the art. Process 300 shall be described with reference to FIGS. 1-2. However, process 300 is not limited to those example aspects.

In some aspects, analysis and orchestration platform 104 may receive conflicting commands from reactor 134 and/or multiple users. For example, a user of client device 106 may submit a command that conflicts with a command sequence implemented by reactor 134. In another example, multiple users of multiple client devices 106 may submit conflicting commands. In yet another example, reactor 134 may implement conflicting playbooks. For example, if both an unauthorized person and unauthorized vehicle are detected by a first camera, reactor 134 may simultaneously implement a first playbook to track the person and a second playbook to track the vehicle, even though the first camera cannot complete both of these tasks simultaneously. In these situations, analysis and orchestration platform 104 may leverage global control orchestrator 136 to resolve conflicts.

At 302, global control orchestrator 136 may receive conflicting commands. For example, reactor 134 may instruct a first camera to move to track an unidentified person while a user of client device 106 may instruct the first camera to point towards a critical power supply so it can be inspected for damage.

At 304, global control orchestrator 136 may analyze the conflicting commands. For example, the global control orchestrator may enforce conflict arbitration rules to determine which command should take precedent. The conflict arbitration rules may prioritize commands based on criticality and current security posture. For example, tracking an unidentified person may take precedence over tracking an unattended dog. The conflict arbitration rules may also take into account the hierarchy of different users. For example, commands received from system operators may take priority over commands received from other security personnel. Furthermore, in some aspects, user commands may take precedence over commands initiated by reactor 134.

At 306, global control orchestrator 136 may implement the higher priority command. For example, the global control orchestrator may stop object tracking initiated by reactor 134 to implement camera controls submitted by a user of client device 106. Global control orchestrator 136 may send the higher priority command directly to a sensor (e.g., a camera) or control interface via a REST API, or may publish command events to event broker 128.

At 308, the higher priority command is completed and the global control orchestrator may implement the lower priority command(s). For example, after the user initiated camera movements have ended, global control orchestrator 136 and/or reactor 134 may re-implement the object tracking. Lower priority commands may be published via event broker 128 or sent directly to sensors 102/command services 138 via REST APIs 130.

In some aspects, 302-308 may repeat each time a conflicting event is detected within analysis and orchestration platform 104.

Examples of specific methods for conflict resolution have been described herein. However, these examples are not meant to be limiting nor meant to represent an exhaustive list of possible implementations. The scope of the technology disclosed herein is not limited to only these examples, and other implementations are contemplated as appreciated by one skilled in the art.

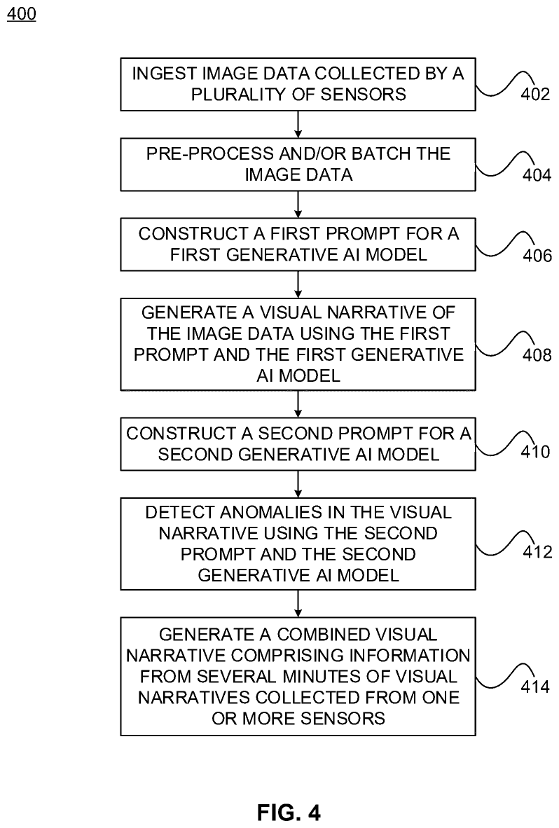

FIG. 4 shows a flowchart of an example process 400, according to some aspects. Process 400 may provide an example method for processing and analyzing incoming data using an artificial intelligence based module. The steps described in process 400 may be implemented by one or more micro services within analysis and orchestration platform 104 (e.g., data processing modules 122, data integration services 118). Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art. Operations described in process 400 may be implemented entirely on premises (e.g., by edge computing nodes). Process 400 shall be described with reference to FIGS. 1-3. However, process 400 is not limited to these example aspects.

At 402, analysis and orchestration platform 104 may ingest image data captured by a plurality of sensors. For example, analysis and orchestration platform 104 may leverage data integration services 118 to retrieve image data by querying API endpoints and/or by implementing automatic sampling techniques. The image data may include video fragments. In some aspects, data integration services 118 may implement an intelligent pre-fetching algorithm for proactively retrieving image fragments ahead of scheduled inference cycles. The pre-fetching mechanism may anticipate data needs based on recent sensor activity, historical data rates, and/or sensor-specific triggers, allowing the system to maintain low-latency processing, even under varying network conditions.

At 404, analysis and orchestration platform 104 may pre-process and/or batch the image data. For example, analysis and orchestration platform 104 may leverage data integration services 118 (or data processing modules 122) to synchronize, time stamp, and normalize image data fragments for quality and consistency. In some aspects, the data may be batched. Batch size may be chosen based on the size of image data fragments, the total amount of memory needed to analyze the image data fragments, and/or the current memory utilization within one or more processors (e.g., graphical processing units). Furthermore, the batch size may be adjusted dynamically based on graphical processing unit load or incoming data rates. In some aspects, image batches are alternately loaded into two or more graphical processing units (GPU). These techniques can speed up data processing and allow for creating of visual narratives from image data in real-time (or near real-time).

At 406, a data processing module 122 within analysis and orchestration platform 104 may construct a first prompt for a first generative AI model. The first prompt may include rich, context aware instructions that help the first generative AI model interpret what is occurring within the image data. In some aspects, analysis and orchestration platform 104 may dynamically select and modify the first prompt (e.g., from a prompt template) based on environmental metadata, such as time of day, weather conditions, and sensor status. For example, in the daytime, the first prompt may prioritize object identification under full illumination, while during the nighttime the first prompt may be adjusted to account for low-light or infrared image inputs. In one non-limiting example, the prompt may include, “These images were captured at 02:13 AM under low-light conditions.” This adaptive prompt strategy can improve inference precision, reduce model hallucination rates, and/or enhance overall situational awareness across diverse operational scenarios. The pre-fetching and adaptive prompting mechanisms may contribute significantly to real-time performance, resilience, and/or operational accuracy in resource-constrained and dynamic environments. In some aspects, the first prompt may also specify observation objectives. For example, prompt may instruct the AI model to, “Identify any human activity, vehicles, or suspicious objects.” The first prompt may be created by populating a prompt template.

At 408, the data processing module 122 may generate a visual narrative of the image data. For example, the data processing module 122 may integrate the image data (or a batch of the image data) into the first prompt that is sent to the first generative artificial intelligence (AI) model. The first generative AI model may include a large language model (LLM), or the like. In response to the first prompt, the first generative AI model may return a textual summary of the image data.

At 410, the data processing module 122 may construct a second prompt for a second generative AI model. The second prompt may include the visual narrative and instructions to detect anomalies and/or instructions to refine (e.g., enrich) the visual narrative. In some aspects, the second prompt can be generated from a prompt template.

At 412, the data processing module 122 may perform anomaly detection on the visual narrative generated at 406. For example, the data processing module 122 may send the second prompt to the second generative AI model. The second generative AI model may include a large language model, and may be the same, or a different model than the first generative AI model. Outputs of the second generative AI model intelligence model may include real-time alerts and/or visual narratives with enriched context. Alerts and/or visual narratives may be sent to other micro services within analysis and orchestration platform 104 via REST APIs 130 or event broker 128. Alerts and/or visual narratives may be stored in storage service 120.

In some aspects, 402-412 may be completed for a single image fragment or a batch of image fragments in about 1.5 seconds or less using off-the-shelf (e.g., generic, pre-built) generative AI models. When generative AI models are trained specifically for image processing tasks, 402-408 may be completed in tens of milliseconds. Speed and accuracy of the generative AI models may also be improved through the implementation of a closed loop AI optimization methods. For example, a user may provide feedback that is used to retrain the generative AI models and/or update the prompts.

In some aspects, 402-412 are continuously repeated for multiple sensors within a multi-modal sensor system.

At 414 the data processing module 122 may generate a combined visual narrative. The combined visual narrative may combine several minutes' worth of visual narratives/alerts from multiple sensors (e.g., 15 minutes worth of data from 3 different sensors, etc.) In some aspects, the data processing module may fetch previous visual narratives from the storage service and integrate them into a prompt that is sent to a third generative AI model. The third generative AI model may include a large language model or the like. The prompt may instruct the third generative AI model to summarize the data into a combined visual narrative. The combined visual narrative output by the third generative AI model may be sent to other services and/or a user of client device 106 via a REST API 130 and/or event broker 128.

Examples of specific methods for ingesting and analyzing sensor data have been described herein. However, these examples are not meant to be limiting nor meant to represent an exhaustive list of possible implementations. The scope of the technology disclosed herein is not limited to only these examples, and other implementations are contemplated as appreciated by one skilled in the art.

The aspects described in FIGS. 1-4 are useful for detecting, evaluating, and responding to security threats. The situation described below illustrates how the system and methods described in FIGS. 1-4 may be implemented in the field. The situation described below is non-liming and other applications of the technology described herein may be implemented based on the knowledge of a person of ordinary skill in the art. The example situation is now described.

Situation: Located at the north end of a host nation military airfield in an undisclosed location in a host nation, U.S. Forward Operating Base (FOB) Eagle is a U.S. operating element collocated with the host nation military. It occupies the northern part of the larger host nation facility. The FOB shares part of its perimeter facing the airfield with the host nation. The northern half of the base faces outward towards the countryside. The base is on the outskirts of a large town outside the host nation's capital. The main base gate is manned by host nation personnel, while FOB Eagle's gates are manned by U.S. personnel. The military base entrance is located on a main thoroughfare, while the north and east sides of the base are bordered by rural areas.

The base supports Counterterrorism (CT) Operations but recently adapted the scope of its operations to cover newly arrived “Mercenaries” from and adversary nation, as requested by the host country. FOB Eagle has operated for several years, partnering with the host nation on joint endeavors against terrorist groups in the country; however, the country recently went through a highly contested election and a change of President with a political party which had enjoyed a majority in parliament. Since then, the host nation's policies have skewed towards the adversary nation. Subsequently, mercenaries from the adversary nation entered the country at the invitation of the new President, which led to several security encounters near FOB Eagle. Command elements have alerted the security team that the mercenary presence represents not only a security risk, but a Counterintelligence (CI) risk as well. Eagle base personnel now must be vigilant not only of the existing CT threat—including elements which have vowed to overthrow the government and attack any westerner in the country—but of an increasingly hostile, irregular, and well-armed mercenary force with advanced Military equipment including armored vehicles. Complicating the threat, due to the irregular nature of the mercenary force, FOB Eagle personnel must adhere to the commander's Rules of Engagement (ROE) and not engage mercenary personnel unless under direct attack.

Scenario: Security Operator Tony takes over for Lee for the day shift, receiving his update from the operator about events the night before as well as any relevant intelligence updates. There are no updates besides “all quiet.”

12:00: After taking a seat, Tony logs into multi-modal sensor system 100 with his credentials and scans his six displays, looking left to right to survey the external perimeter, the internal Common Operating Picture (COP), and the command center display. Everything appears normal. Tony begins reading his OSINT information feed on his right screen when he receives an event trigger notifying him that a LIDAR sensor in zone #4 is above its temperature range and another LIDAR in zone #4 is “offline.”

The overtemperature event is presented by a yellow animated icon (slow pulse) with an accompanying aural alert while the “outage” is presented visually as an orange icon with an accompanying aural alarm. Simultaneously, the event trigger is presented to the Zone #4 guards on their mobile device as well as the facility engineer (user #4)

Tony acknowledges both event triggers which suppresses the aural alarm. The Zone 4 guards and the facility engineer (user #7) were presented identical information on their handheld devices and responded in the same manner as Tony with acknowledgments.

The facility engineer also acknowledged the alerts with a message stating he was enroute to investigate both sensors. 30 seconds later, the overtemperatured sensor changed its status and presented an event trigger with an animated icon that turned from yellow to orange, along with a change in the accompanying aural alarm, as the sensor has now completely failed and is offline. On the geospatial overlay reference of the facility/perimeter Common Operating Picture (COP), multi-modal sensor system 100 displays the faulty sensors (with corresponding animated/colored icons in the position in which the sensor is located) to the relevant stakeholders.

12:15: Shortly thereafter, Tony receives a “yellow” alert notifying him of an OSINT report detailing the potential arrival of additional mercenaries to the host country. The report indicates the mercenaries may arrive via the airfield collocated with FOB Eagle. Tony creates an alert for his security chat group alerting the full security team of the OSINT information. Tony also checks an icon that flags the alert to his higher command and his base leadership team (Users #2 and #3). After an acknowledgment threshold time limit exceeds 10 minutes, Tony receives notification from multi-modal sensor system 100 that only 14 of 15 guards have acknowledged the yellow alert. Guard #15, who did not acknowledge the alert, is re-prompted by multi-modal sensor system 100 on his handheld device with a more significant icon and aural alert, after which he acknowledges the alert. To reduce user engagement, the multi-modal sensor system 100 does not send Tony an alert when all recipients have read and acknowledged alerts, but instead simply changes the original alert status to green. It will only alert Tony if a recipient does not acknowledge his initial alert. In summary, a green icon indicates to Tony that all recipients have read and acknowledged the alert he has raised.

12:30: User #4 (facility engineer) reports via his multi-modal sensor system handheld device (e.g., client device 106) using its Push-to-Talk (PTT) communication and within the event chat that the once overtemperatured (now inoperable) LIDAR was caused by a nearby convex mirror. The mirror, intended to prevent vehicle blind spot collisions in the parking area, was positioned where the sun was refracting an intense beam of light on the LIDAR. User #4 also states that the other “outage” (LIDAR's CAT 6 connection) was accidentally cut by a local national trimming nearby bushes. Within seconds, both sensors' status on all user device COPS' has returned to normal with each of their animated icons becoming green, stationary, and a change in tone to silent.

12:45: A separate event is triggered. For background, Zone 2 sensors consist of numerous Unattended Ground Sensors (UGS) and various LIDAR and EO/IR cameras. Zone 2 is adjacent to a highly sensitive area of the facility. Its threshold parameters are uniquely set for detection with a standoff of up to 250 meters (UGS range) in light vegetation/brush. There is a draw (terrain feature) that runs parallel to the fence line at 180 meters (LIDAR range). For reference, the EO/IR cameras' range of effectiveness for object detection varies pending environmental conditions, anywhere from 25 to 300 meters. Today conditions limit the EO/IR sensor object detection to 150 meters. Due to grazing by goats in the local area and occasional false alarms by the UGS when distinguishing between bipeds and quadrupeds, Zone 2 is set to trigger a Red Critical Alert only when a combination of an UGS trigger and/or either the LIDAR or camera detects a human (biped). If a quadruped was detected, a yellow alert would be sent. In this scenario, Tony and all security personnel receive critical condition event triggers on all connected multiple devices receiving the requisite visual (red, flashing) and aural alarms, as well as a voice prompt stating “Zone 2 Critical”.

In addition, on the COP, the Zone 2 overlay is highlighted transparent red. The triggered UGS and its range of detection (human 10 meters) is also geospatially displayed on the COP with a concentric ring around the sensor. Simultaneously, multi-modal sensor system 100 brings the LIDAR data to the forefront of the screen allowing for all the features seen in the Ouster Gemini Software (and others). Users see that the object detection via the LIDAR is red, portraying a critical condition with a red box around the humans while also providing additional geo data when that overlay is selected.

Simultaneously and queued from the LiDAR, the main EO/IR cameras have automatically slewed to where the LIDAR detected 4 humans (bipeds) and 6 quadrupeds. Multi-modal sensor system 100 has automatically counted and displayed the numerical value accordingly. The LIDAR and the cameras are also providing a “sensor point of interest” on the COP with a range and bearing to the targets. Because Zone 2 is categorized as highly sensitive, multi-modal sensor system 100 has activated the base intruder deterrence system, specifically, multi-modal sensor system 100 has slewed to queue Zone 2's Long-Range Acoustic Device (LRAD) which automatically transmits pre-recorded warnings (or live verbal commands) as well as a 143 dB siren to affect an intruder's hearing and cause temporary disorientation. During a Period of Darkness (POD) scenario, multi-modal sensor system 100 would slew to queue a separate intruder deterrence system, specifically, a focusable spotlight that directs 12 million candlepower of white light to illuminate a wide or narrow field of view as determined by the system operator. A strobe mode temporarily impairs an intruder's vision and is especially effective against nighttime visitors. The deterrence systems and their status are also presented geospatially on the COP with sensor points of interest.

Because the current environmental conditions are preventing the EO camera from detecting objects further than 75 meters, the LiDAR sensors were the first to detect the four humans and 6 quadrupeds. Once the intruders got closer, the EO/IR camera detects the person/animals and provides object recognition data and information accordingly. Tony and the multi-modal sensor fusion system users now clearly see a group of four men with a herd of goats 75 meters from the fence line. A Zone 2 guard assesses the threat to be low and pauses the intruder deterrence systems; however, one of the men slowly approaches the fence waving a document in a foreign language. A Zone 2 guard transmits a photo of the document to Tony, and multi-modal sensor fusion system immediately translates the document which turns out to be a benign letter of authorization by the host nation to use public lands for grazing. In addition, another Zone 2 guard transmits the call sign of the base linguist to all multi-modal sensor system users via his multi-modal sensor system handheld device. The linguist replies with confirmation, reports to Zone 2, diffuses the situation, and instructs the herders to depart. Zone 2 status returns to normal.

Tony alerts the security tower closest to the group and adds the information in the chat.

13:15: Guards at the internal perimeter gate next to the airfield—using their mobile app on their phone—alert Tony at the Security Operations Center (SOC) that they can see a military style vehicle driving at a high rate of speed towards the gate along the airfield road. In addition, via multiple sensors set up along a main route approaching the gate, multi-modal sensor fusion system begins tracking and attempting to identify the vehicle at as long a range as possible. On approach, multi-modal sensor system 100 can sense the vehicle (and all vehicles) as soon as the first sensor on the route is tripped. Indicators appear to multi-modal sensor system users that are queued to each vehicle, color-coded for friendly (green), unknown (yellow) or hostile (red).

Simultaneously, Tony has slewed to queue the base's long range EO/IR optic system in the direction of the sensors that detected the vehicles and where the guards reported them. Tony engages the multi-modal sensor system moving target indicator which enables the camera to track the vehicle. Tony also acknowledges the perimeter guards report using the system PTT. As the vehicle approaches, it decreases speed and guards at the internal perimeter gate report it appears to be a host nation vehicle. At the same time, Tony gets an alert of the arrival of a vehicle on his external perimeter screen. The License Plate Reader (LPR) alerts Tony the vehicle license plate is a known liaison plate (via an icon/indicator in green). Additionally, a passive signal collection system provided multi-modal sensor system 100 the data to alert Tony that it has picked up a known Bluetooth device (also via an icon/indicator in green) connected to Captain Lamou's phone, the host nation liaison officer at the airfield for FOB Eagle. Additional information, including vehicle type and color, as well as bio data on personnel is available to users by clicking on the displayed indicators/icons associated with the object they have sensed.

Guards at the front gate report Lamou's arrival. At the same time, the signal collection system provides alerts for two unknown Bluetooth devices in the vicinity of front gate (via an icon/indicator in yellow). Tony looks at the front gate camera feed located on the top left screen and notes two other people in the vehicle. Capt. Lamou tells the front gate security team there will be an aircraft landing on the airfield in 20 minutes and the Americans are not to leave base while the aircraft lands and unloads.

Via the chat, Tony alerts the base commander of the discussion with Capt. Lamou and conveys the information Capt. Lamou provided regarding remaining on base. Tony also alerts the front gate team to notify Capt. Lamou that the base has two vehicles out in town on a logistics run and inform Capt. Lamou that they are due back in approximately 30 minutes. In response, the gate team reports Capt. Lamou stated he will remain at the gate until the aircraft departs in approximately one hour.

13:30: Following this exchange, Tony receives an alert via the OSINT tool notifying him of a discussion of a potential coup in the host nation, noting the recent election was—and remains—contested, with claims of voter fraud and election meddling rampant among both principle political parties. Open Source (OS) reporting indicates the population in the surrounding area is angry about the outcome of the election and the presence of adversary nation mercenaries. Tony passes the OS report to users via the security chat. Tony additionally notes the base security team has observed a handful of protesters outside the facility's main (host nation) gate over the past few days.

13:45: The facility's base operations (User #8) highlight an incoming flight that was not previously scheduled by the host country. Using the ADS-B signal (sensor) that is overlayed on the COP, Tony slews to cue the base long range EO/IR camera. Tony tracks a large cargo transport aircraft on approach to the airfield, noting to the base commander and the security team it is an adversary nation aircraft. When Tony hovers over the aircraft's icon in the ADS-B/COP overlay, multi-modal sensor system 100 presents the detailed ADS-B information. Multi-modal sensor system 100 presents Tony with information from ADS-B that the aircraft type is indeed an adversary nation aircraft along with all other ADS-B information (departure point, flight route, destination, speed, altitude, etc.) The aircraft subsequently lands and taxis to the far end (south) of the runway. Tony watches via the camera as dozens of what appear to be adversary nation mercenaries offload the aircraft.

Simultaneously, Tony's base operations report the arrival of the FOB Eagle U.S. logistics team who are calling in from the main (host nation) military gate. In a multi-modal sensor system chat group, the team reports a larger than usual group of protesters near the gate, and indicates the protesters appear to be more agitated than normal. A logistics team member (user #10) captures a video of the protest and sends the video in group chat via multi-modal sensor system 100. The system also displays user #10 geospatially on the COP and when any other user in the system group clicks on user #10's icon, the system presents relevant data (location, biodata, etc.). Accordingly, host nation guards at the main gate must clear a path for the U.S. logistics team to enter the base. Tony adds this to the security chat.

As the U.S. logistics team approaches FOB Eagle from the internal perimeter along the airfield road, base officers observe two armored vehicles leave the adversary nation aircraft being offloaded and follow the U.S. logistics team's vehicles. Tony reports this to the interior gate team. In addition, as with the approach to the base's main (host nation) gate, sensors placed along the internal base road utilize License Plate Reader (LPR) collection and alert Tony the armored vehicles are unknown non-liaison vehicles (via an icon/indicator in yellow), in proximity to the U.S. logistics team vehicle (indicated via an icon in green). Additionally, the passive signal detection system provides information for multiple unknown Bluetooth devices (via an icon/indicator in yellow).

Additional detailed information is available to users by clicking on the displayed icons.

13:45: At the same time, the system users are alerted (via icons/indicators in yellow) to a group of locals moving outside the base perimeter nearby zone 3 with a large mobile cart where the U.S. FOB Eagle perimeter fence meets the host nation fence. Additional information (such as LIDAR or Camera Feed) is available to users by clicking on the displayed icons, and the system AI offers recommended actions to the SOC. Tony is additionally alerted via a camera feed and with both the icon and camera feed indicators, and multi-modal sensor system 100 counts and presents that there are four locals with the mobile cart. Tony conducts a search in multi-modal sensor system events using the keyword “cart.” Accordingly, Multi-modal sensor system 100 displays a list of events that contained the word or a photograph of a “cart”. The multi-modal sensor system 100 yields a notice of past reporting, where there were several local vendors who set up carts near the base. The camera feed does not indicate anything unusual, and the icons indicate yellow (unknown, versus red for hostile), but Tony notes via his keyword search that the cart has been observed around the base several times in the past week with two men, in this case four men are observed. Tony communicates this information via the chat to the security tower closest to the cart and to the overall security group to ensure they are synchronized on all information. All users acknowledge on the multi-modal sensor system.

14:00: Meanwhile, the U.S. FOB Eagle logistics vehicles arrive at the gate. Capt. Lamou and his vehicle, however, are blocking the gate. The system License Place Reader (LPR) registers the two known U.S. vehicle plates and confirms their tire pressure monitoring systems match the U.S. vehicles on record (via an icon/indicator in green). As the U.S. logistics team arrives, the host nation vehicle does not move despite repeated requests from the guards at the gate.

14:15: The U.S. logistics team exits their vehicles to talk to Capt. Lamou. At the same time, the two armored vehicles that exited the adversary nation aircraft arrive, with the gate guards noting these are adversary nation vehicles. The individuals inside the adversary nation vehicles exit their vehicles. The multi-modal sensor system 100 quickly alerts users the individuals are armed, recognizing the weapons in their hands (via a red icon/indicator).

The multi-modal sensor system 100 provides additional situation medium threshold alerts noting the unknown license plates (indicated in yellow), and new Bluetooth devices, which are all unknown (indicated in yellow). The gate guard team is concerned that the situation could escalate and report the armed adversary nation individuals appear angry and are yelling in a foreign language. The passengers in Capt. Lamou's vehicle exit their vehicles and a front gate camera of the multi-modal sensor system 100 positively identifies an adversary nation consulate officer with the first name “Alexy” (last name unknown).

14:30: As the adversary nation individuals yell at the U.S. logistics team, the language barrier seems to escalate the situation. The gate security team, using the handheld the multi-modal sensor system app, point their cameras at the armed adversary nation individuals and record them, registering their biometrics. The senior guard attempts to speak with Alexy, using the translation features in the system handheld application. Per his report, Alexy states the armed adversary nation individuals are upset the U.S. logistics team's vehicles came too close to the cargo aircraft.

Capt. Lamou, who is now standing between the U.S. logistics team and the armed adversary nation individuals, is trying to de-escalate the situation. Fortunately, Tony can see the U.S. logistics team is remaining calm and relying on Capt. Lamou to intervene. Tony reports this information to the base commander, who in turn relays the information higher via the appropriate chain of command via a separate system group chat in the higher commands multi-modal sensor system application. The higher command can playback the video that the guards took of the adversary nation individuals during their rage.

14:35: Unexpectedly, an icon displayed to ALL multi-modal sensor system users indicates there is an individual with a KNOWN identity in zone 5, an area only authorized for cleared U.S. Persons. Tony highlights “Jenneau, a foreign worker” on the LIDAR system tasking it to track him on the facility. Any user can click on the icon to gain more information on the individual's identity and which sensor(s) detected the intrusion.

A biometric-capable camera of multi-modal sensor system 100 confirms Jenneau is the individual detected, and that the RFID chip in his badge matches Jenneau's ID. As the area is for U.S. Persons only, the multi-modal sensor system 100 dispatches a security officer to remove Jenneau from the area. The security officer acknowledges the instructions. Tony has full visibility to the multi-modal sensor system action. The security officer reports in the multi-modal sensor system 100 that Jenneau entered through a door that was propped open and that Jenneau was trying to pick up cigarette butts he saw in the area. The officer reports Jenneau had the cigarette butts in his hand when confronted. The security guard notes there were people moving boxes around a few minutes earlier and had likely propped open the door. Jenneau is removed from the area and given more guidance on areas he is not allowed to enter. Tony notes this in the multi-modal sensor system log.

14:50: Separately, the gate security team handling the armed adversary nation individuals and U.S. logistics team is successful with Capt. Lamou's help in de-escalating the situation, and the U.S. logistics team is allowed to enter inside the base. The system LPRs continue to confirm the vehicles entering the base with the arrival of five known Bluetooth and WIFI devices (via a green indicator/icon).

15:00: Tony is alerted via OSINT to violent clashes between protesters and the newly installed government's troops in the downtown area of the capital. OSINT news reports highlight the growing dissatisfaction with the adversary nation mercenaries and their heavy-handed tactics in supporting the host nation's current President.

15:55: Within an hour, a multi-modal sensor counter-drone system and an acoustic sensor both detect a Small Unmanned Aerial System (SUAS) and display a range/bearing of the UAS from the base. Tony is alerted to the drone's presence with the multi-modal sensor system via an icon/indicator in red and associated aural alert/voice prompts.

16:15: One of the guards in zone 6 locates the SUAV over the host nation segment of the base, and assesses it was likely launched somewhere in the vicinity of the main thoroughfare near the base which is crowded with vendors and customers at this time of day. Tony alerts the internal gate to relay this message to Capt. Lamou, who was still at the gate talking to the security team. Should the SUAS reach distance thresholds established within the multi-modal sensor system 100 from the U.S. FOB Eagle, the system AI offers recommendations to Tony for potential next steps based on the known/unknown/hostile (green, yellow, and red) and type (shape) indicators. A multi-modal sensor system status bar indicates that the counter UAS system is primed and ready to respond.

16:25: Tony is alerted that a UGS system placed in a dead space in a small draw (terrain feature) 500 meters to the north of the base has detected footsteps. The multi-modal sensor system 100 displays the event trigger (via indicators/icons in yellow). The area, which is concealed from FOB Eagle's camera system and hidden by brush, is a persistent concern for the security team.

16:30: The multi-modal sensor system 100 advises the automatic launch of the Easy Aerial EGV-90 UAS to obtain better situational awareness based on the threshold parameters set in the multi-modal sensor system. Tony has the option to stop the launch of the EGV-90 with an EO/IR camera; however, he allows the multi-modal sensor system 100 to continue with the response to provide additional surveillance coverage. Within seconds, acoustic sensors alert Tony to an anomaly sound (gunshot or explosion). The multi-modal sensor system 100 presents this information with a range and bearing from the sensor. On the COP, Tony sees that both the UGS and acoustic sensors are reporting the same location. The UAS' EO/IR camera confirms the men in the draw with object tracking and the individuals' icons are updated to red (to indicate they are hostile). As this occurs, Tony sends additional alerts to the security team and base via the chat alert system for full situational awareness.

16:45: Tony selects the “incoming” broadcast to all the multi-modal sensor system users who hear the voice prompt on all system devices. The call alerting personnel to incoming fire is broadcast across the base. With the UAV now in position, Tony can see three men located in a small clearing in the draw with what appears to be a mortar system. Tony observes the men fire two more rounds. Tony issues an alert to the security team which displays the location of the mortar team. The team at the gate relays the information to Capt. Lamou.

17:00: Capt. Lamou reports three rounds have hit the airfield close to the adversary nation aircraft, but no one was hurt, and nothing was damaged. Capt. Lamou asks for any additional information, and Tony relays the three men are running away from the base with their mortar system. Tony via his UAS can see the men jump into a small white pickup truck and drive north away from the base. Tony enables the MTI via the UAS and the UAS continues to follow the truck. The gate guards show Capt. Lamou the video playback and still photos of the men and the truck. The guard “airdrops” the video and pictures to Capt. Lamou for further distribution to host nation security elements.

17:30: Capt. Lamou reports that the men were stopped by local police and detained. Capt. Lamou thanks FOB Eagle for sharing this information, noting it was the FOB's timely information which led to the men's arrest and prevented an incident with the adversary nation individuals. Given the precarious security situation in-country, this was particularly helpful as Capt. Lamou indicated the adversary nation individuals believed the fire had come from the Americans.

Capt. Lamou advised the adversary nation individuals that the FOB was in fact not the source of the fire but had detected the attack first and provided the only information on the attackers—who, it turns out, were linked to a terrorist group by local police.

18:00: Tony soon is relieved of his shift and reports the day's events to his replacement.

FIG. 5 depicts an example computer system useful for implementing various aspects described herein.

Various aspects may be implemented, for example, using one or more well-known computer systems, such as computer system 500 shown in FIG. 5. One or more computer systems 500 may be used, for example, to implement any of the aspects discussed herein, as well as combinations and sub-combinations thereof. For example, the example computer system may be implemented as part of sensors 102, analysis and orchestration platform 104, and client device 106. Some implementations may include one or more of the example computer systems operating locally or distributed across one or more server sites.

Computer system 500 may include one or more processors (also called central processing units, or CPUs), such as a processor 504. Processor 504 may be connected to a communication infrastructure or bus 506.

Computer system 500 may also include customer input/output device(s) 502, such as monitors, keyboards, pointing devices, etc., which may communicate with communication infrastructure 506 through customer input/output interface(s) 502.

One or more of processors 504 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 516. Removable storage unit 516 may include a computer usable or readable storage device having stored thereon computer software (control logic) and/or data. Removable storage unit 516 may be a floppy disk, magnetic tape, compact disk, DVD, optical storage disk, and/any other computer data storage device. Removable storage drive 514 may read from and/or write to removable storage unit 516.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML Customer Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 516 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 5. In particular, aspects can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A system for processing image data in real time to detect anomalies, comprising:
a plurality of sensors;
one or more memories; and
at least one processor each coupled to at least one of the memories and configured to perform operations comprising:
ingesting image data collected by the plurality of sensors;
grouping the image data into a plurality of batches based on image size or memory utilization of at least one of the memories;
constructing a first prompt for a first generative artificial intelligence (AI) model using metadata associated with the image data;
generating a visual narrative for each batch of the plurality of batches using the first prompt and the first generative AI model;
constructing a second prompt for a second generative AI model using one or more of the visual narratives; and
detecting an anomaly within one or more of the visual narratives using the second prompt and the second generative AI model.

2. The system of claim 1, wherein the operations further comprise:
constructing a third prompt for a third generative AI model based on one or more of the visual narratives, wherein the one or more of the visual narratives are generated from image data collected by at least two sensors in the plurality of sensors; and
generating a combined summary that integrates the one or more visual narratives using the third prompt and the third generative AI model.

3. The system of claim 1, wherein the operations further comprise:
initiating one or more actions based on the anomaly, wherein the one or more actions include controlling one or more sensors in the plurality of sensors.

4. The system of claim 3, wherein the operations further comprise:
determining the one or more actions by leveraging an AI model, wherein an input to the AI model includes the anomaly.

5. The system of claim 1, wherein the metadata includes a time of capture and a lighting condition for an image within the image data.

6. The system of claim 1, wherein constructing the first prompt comprises:
populating a prompt template with the metadata.

7. The system of claim 1, wherein the ingesting, grouping, constructing, generating, constructing, and detecting occur in less than about 1.5 seconds.

8. A computer-implemented method for processing image data in real time, comprising:
ingesting image data collected by a plurality of sensors;
grouping the image data into a plurality of batches based on image size or memory utilization of one or more computer systems;
constructing a first prompt for a first generative artificial intelligence (AI) model based on metadata associated with the image data;
generating a visual narrative for each batch in the plurality of batches using the first prompt and the first generative AI model;
constructing a second prompt for a second generative AI model using one or more of the visual narratives; and
detecting an anomaly within one or more of the visual narratives using the second prompt and the second generative AI model.

9. The computer-implemented method of claim 8, further comprising:
constructing a third prompt for a third generative AI model based on one or more of the visual narratives, wherein the one or more of the visual narratives are generated from image data collected by at least two sensors in the plurality of sensors; and
generating a combined summary that integrates the one or more visual narratives using the third prompt and the third generative AI model.

10. The computer-implemented method of claim 8, further comprising:
initiating one or more actions based on the anomaly, wherein the one or more actions include controlling one or more sensors in the plurality of sensors.

11. The computer-implemented method of claim 10, further comprising:
determining the one or more actions by leveraging an AI model, wherein an input to the AI model includes the anomaly.

12. The computer-implemented method of claim 8, wherein the metadata includes a time of capture and a lighting condition for an image within the image data.

13. The computer-implemented method of claim 12, wherein constructing the first prompt comprises:
populating a prompt template with the metadata.

14. The computer-implemented method of claim 8, wherein the ingesting, grouping, constructing, generating, constructing, and detecting occur in less than about 1.5 seconds.

15. A non-transitory computer-readable medium having instructions stored thereon that, when executed by at least one computing device, cause the at least one computing device to perform operations comprising:
ingesting image data collected by a plurality of sensors;
grouping the image data into a plurality of batches based on image size or memory utilization of the at least one computing device;
constructing a first prompt for a first generative artificial intelligence (AI) model based on metadata associated with the image data;
generating a visual narrative for each batch in the plurality of batches using the first prompt and the first generative AI model;
constructing a second prompt for a second generative AI model using one or more of the visual narratives; and
detecting an anomaly within one or more of the visual narratives using the second prompt and the second generative AI model.

16. The non-transitory computer-readable medium of claim 15, the operations further comprising:
constructing a third prompt for a third generative AI model based on one or more of the visual narratives, wherein the one or more of the visual narratives are generated from image data collected by at least two sensors in the plurality of sensors; and
generating a combined summary that integrates the one or more visual narratives using the third prompt and the third generative AI model.

17. The non-transitory computer-readable storage medium of claim 15, the operations further comprising:
initiating one or more actions based on the anomaly, wherein the one or more actions include controlling one or more sensors in the plurality of sensors.

18. The non-transitory computer-readable storage medium of claim 17, the operations further comprising:
determining the one or more actions by leveraging an AI model, wherein an input to the AI model include the anomaly.

19. The non-transitory computer-readable storage medium of claim 15, wherein metadata associated with the image data includes a time of capture and a lighting condition for an image within the image data.

20. The non-transitory computer-readable storage medium of claim 15, wherein the ingesting, grouping, constructing, generating, constructing, and detecting occur in less than about 1.5 seconds.
